(19) United States
(12) Patent Application Publication
(10) Pub. No.: US 2006/0246873 A1
(43) Pub. Date: Nov. 2, 2006

(54) Method for making calling card telephone calls using a mobile telephone

(75) Inventors: Utpal Nayan Das, Noida (IN); Richa Agrawal, Patiala (IN); Jibu Joseph, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/117,923

(22) Filed: Apr. 29, 2005

(51) Int. Cl. H04M 11/00; H04M 1/68; H04Q 7/20; H04M 3/16; H04M 1/66

(52) U.S. Cl. 455/411; 455/406; 455/466

(57) ABSTRACT

A method for using a mobile telephone to make a calling card telephone call includes imputing calling card information into the mobile telephone, wherein the calling card information includes a calling card access number and a calling card password. The calling card information is saved in a memory of the mobile telephone so that it may be transmitted by the mobile telephone. The saved calling card information is protected with a phone code, enabling a user to make the calling card telephone call from the mobile telephone without re-entering the calling card information by entering a PIN which is compared against the phone code.

### BACKGROUND OF THE INVENTION

The present invention relates generally to the field of telecommunication, and more particularly to a method and apparatus for using a mobile telephone to make a calling card telephone call.

Presently, a user of a telephone (including a mobile telephone) often has the flexibility of placing a telephone call using a number of different calling modes, including, for example, using a calling card. A calling card telephone call is billable to a calling card account. The conventional types of calling cards include a prepaid calling card associated with an account having a prepaid telephone spending limit, and a subscription based calling card associated with an account that is billed monthly. A calling card telephone call, especially an international telephone call, typically costs less than a phone call charged by a mobile telephone operator. To make an exemplary calling card telephone call, a user dials an eleven digit calling card access number associated with the calling card account, such as a 1-800-XXX-XXXX number, enters a four digit calling card password, and then dials a destination number to complete the call. The user is therefore burdened with dialing or entering many digits at his or her telephone, in addition to any required control digits. Moreover, the user is burdened with remembering both the calling card access number and his or her calling card password, both of which typically remain constant throughout many calls using the calling card account. Such burdens are a particular source of inconvenience to a mobile telephone user.

Thus, it is desirable to provide a method and apparatus for using a mobile telephone to make a calling card telephone call, which may enable a mobile telephone user to save time and inconvenience and lower cost when making a telephone call.

### SUMMARY OF THE INVENTION

Accordingly, the present invention is directed to a method for using a mobile telephone to make a calling card telephone call. In an exemplary embodiment, calling card information, which includes a calling card access number and a calling card password, is saved in memory of the mobile telephone. The saved calling card information is protected with a phone code, enabling a user to make the calling card telephone call from the mobile telephone without re-entering the calling card information by entering a PIN that is compared against the phone code. If the entered PIN and phone code match, the calling card information is retrieved from memory and used to place the calling card telephone call by the mobile telephone

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a mobile telephone capable of making a calling card telephone call in accordance with an exemplary embodiment of the present invention;

FIG. 2 is a flow diagram illustrating a method for using a mobile telephone to make a calling card telephone call in accordance with an exemplary embodiment of the present invention;

FIG. 3 shows different screens of a mobile telephone when a calling card access number and a calling card password are saved on the mobile telephone and protected by a phone code in accordance with an exemplary embodiment of the present invention;

FIG. 4 is a flow diagram illustrating a method for using a mobile telephone to make a calling card telephone call based on saved calling card information in accordance with an exemplary embodiment of the present invention;

FIG. 5 is a flow diagram illustrating a method for using a mobile telephone to make a calling card telephone call based on saved calling card information in accordance with an additional exemplary embodiment of the present invention;

FIG. 6 shows different screens of a mobile telephone when saved calling card information is used to make a calling card telephone call in accordance with an exemplary embodiment of the present invention;

FIG. 7 is a flow diagram illustrating a method for using a mobile telephone to make a calling card telephone call based on saved calling card information in accordance with another exemplary embodiment of the present invention; and

FIG. 8 shows different screens of a mobile telephone when saved calling card information is used to make a calling card telephone call in accordance with another exemplary embodiment of the present invention.

### DETAILED DESCRIPTION OF SPECIFIC EMBODIMENTS

Reference will now be made in detail to the presently preferred embodiments of the invention, examples of which are illustrated in the accompanying drawings.

The present invention provides a very efficient and user-friendly method for using a mobile telephone to make a calling card telephone call. The present invention enables a user to save a calling card access number and a calling card password on a mobile telephone in advance, which are protected by a phone code selected by the user. When the user desires to make a calling card telephone call from the mobile telephone, the saved calling card access number and calling card password may be retrieved by the mobile telephone to make the calling card telephone call. This way, the user does not need to remember or dial in person the calling card access number or the calling card password, thereby saving time and inconvenience and lowering cost. Furthermore, since the saved calling card access number and calling card password are protected by the phone code, security is enhanced. For example, if the user loses the mobile telephone or the mobile telephone is stolen from the user, the calling card telephone call may not be made from the mobile telephone since the new user does not know the phone code.

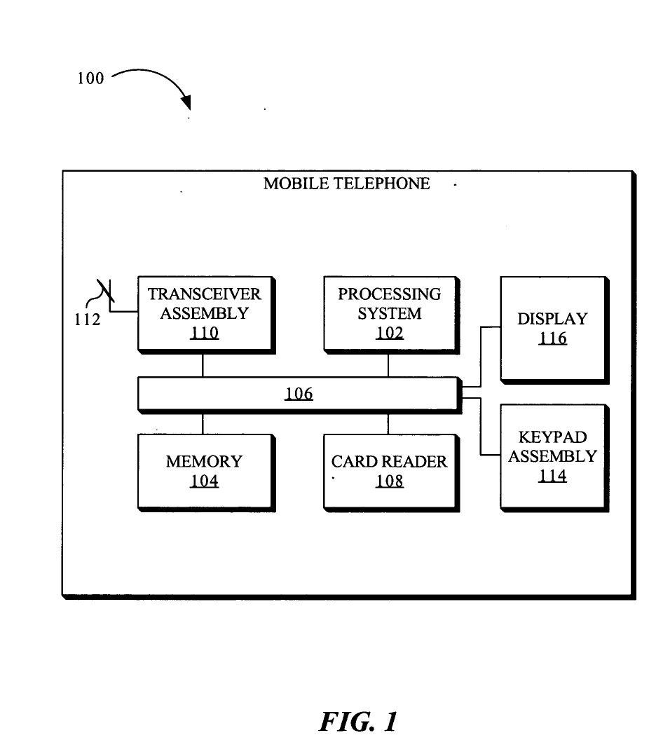

Referring to FIG. 1, a mobile telephone 100 in accordance with an exemplary embodiment of the present invention is described. The mobile telephone 100 provides wireless communication of voice and/or data information with external sources such as a base station, a cellular communication system tower, another mobile communication device, or the like. As shown in FIG. 1, the mobile telephone 100 includes a processing system 102 which controls the overall operation of the mobile telephone 100. The processing system 102 may include a general-purpose microprocessor, a digital signal processor (DSP), an application specific integrated circuit (ASIC), or the like. Exemplary processors include the Advanced RISC Machines (ARM®) microprocessor and the Intel 186 processor which are conventionally used in mobile cellular telephones.

Memory 104 is coupled to the processing system 102 (e.g., via a bus or like interface 106) for storing information including the operating system utilized by the mobile telephone 100, address books, personal greetings, and the like. The memory 104 may comprise both non-volatile and volatile storage devices. In various embodiments, memory 104 utilized by the mobile telephone 100 may include random access memory (RAM), read-only memory (ROM), programmable erasable ROM, flash memory, and the like. Similarly, a data card reader 108 may be coupled to the processing system 104 via the interface 106 for receiving a removable data card providing additional memory for storing information including but not limited to telephone number information for the mobile telephone 100, address book information, security information, and the like. Exemplary data cards include subscriber identification module (SIM) cards, user identification module (UIM) cards, and the like.

A transceiver assembly 110, including a transmitter and receiver or transceiver and an antenna 112 transmit and receive data, including audio data and various other types of data such as text messaging utilized through a wireless communication system (e.g. the base station, the cellular communication system tower, another mobile communication device, or the like). The transceiver assembly 110 may further include signal conditioning circuitry (e.g., analog-to-digital converters, digital-to-analog converters), input/output buffer, and the like.

The mobile telephone 100 may further include an input device such as a keypad assembly 114, for providing entry of alphanumeric information (e.g., telephone numbers, text messages, etc.), commands, and the like by the user. Similarly, a display 116 may be provided for displaying alphanumeric text, control menus (e.g., via a graphic user interface), prompts, and the like to the user. In exemplary embodiments, the mobile telephone 100 may further include common telephone components such as a microphone, a speaker, a ringer, a vibrator, and the like, which are not illustrated. Additionally, it is contemplated that the mobile telephone 100 may provide functions other than telephony. For example, the mobile telephone may provide functions common to handheld computers or personal digital assistants (PDAs), portable gaming devices, or the like. In such embodiments, the mobile telephone 100 further includes a suitable processing system, extended memory, a touch screen overlaying display for tactile input of data, or the like.

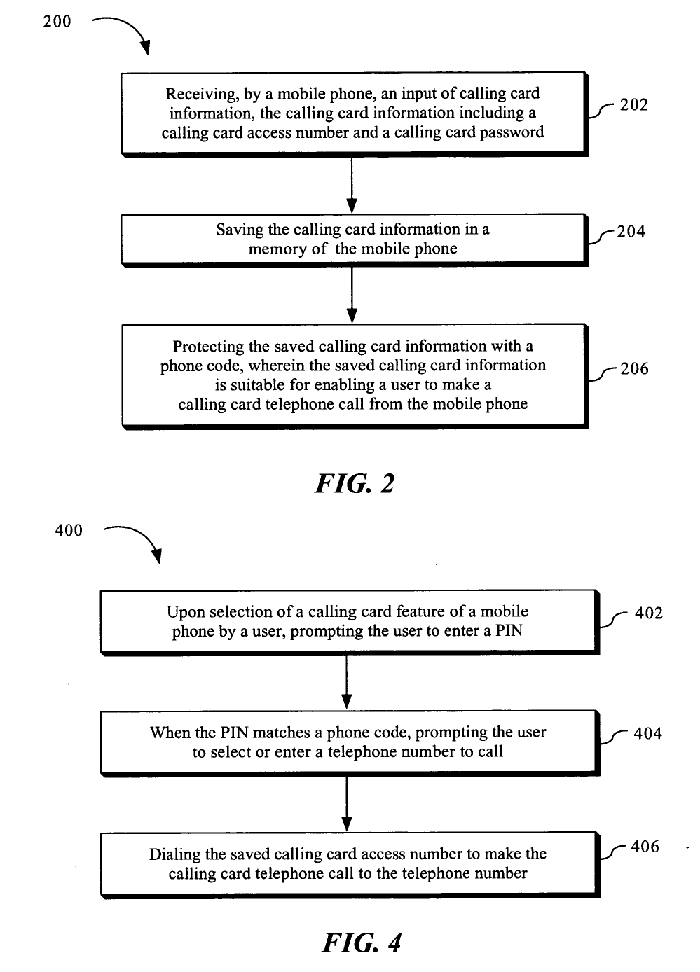

FIG. 2 depicts a method 200 for using a mobile telephone such as the mobile telephone 100 described in the discussion of FIG. 1 to make a calling card telephone call in accordance with an exemplary embodiment of the present invention. An input of calling card information is received by the mobile telephone 202. For example, the calling card information may be entered by the user via the keypad assembly 114 or received from the wireless network via the transceiver assembly 110 shown in FIG. 1. Preferably, the calling card information includes a calling card access number and a calling card password 202. For example, a calling card access number may be an eleven digit number such as 1-800-XXX-XXXX associated with a calling card account, and a calling card password may be a four digit number. It is understood that a calling card access number and a calling card password may include any number of digits without departing from the scope and spirit of the present invention. The calling card information is saved in the memory of the mobile telephone 204. The saved calling card information is protected with a phone code, enabling a user to make the calling card telephone call from the mobile telephone without re-entering the calling card information by entering a PIN (also stored in memory) which is compared against the phone code 206 by the processing system of the mobile telephone. If the PIN and phone code match, the calling card information is retrieved from memory by the processing system. The processing system then automatically dials the calling card access number and transmits the password and telephone number to be called. Thus, the user is required to know only the PIN, and need not know the calling card information in order to place a calling card call. In an exemplary embodiment, the phone code is a 4-digit number. However, it is contemplated that the phone code may include any number of alphanumeric digits without departing from the scope and spirit of the present invention. Optionally, the calling card information may include multiple calling card access numbers and their respective calling card passwords.

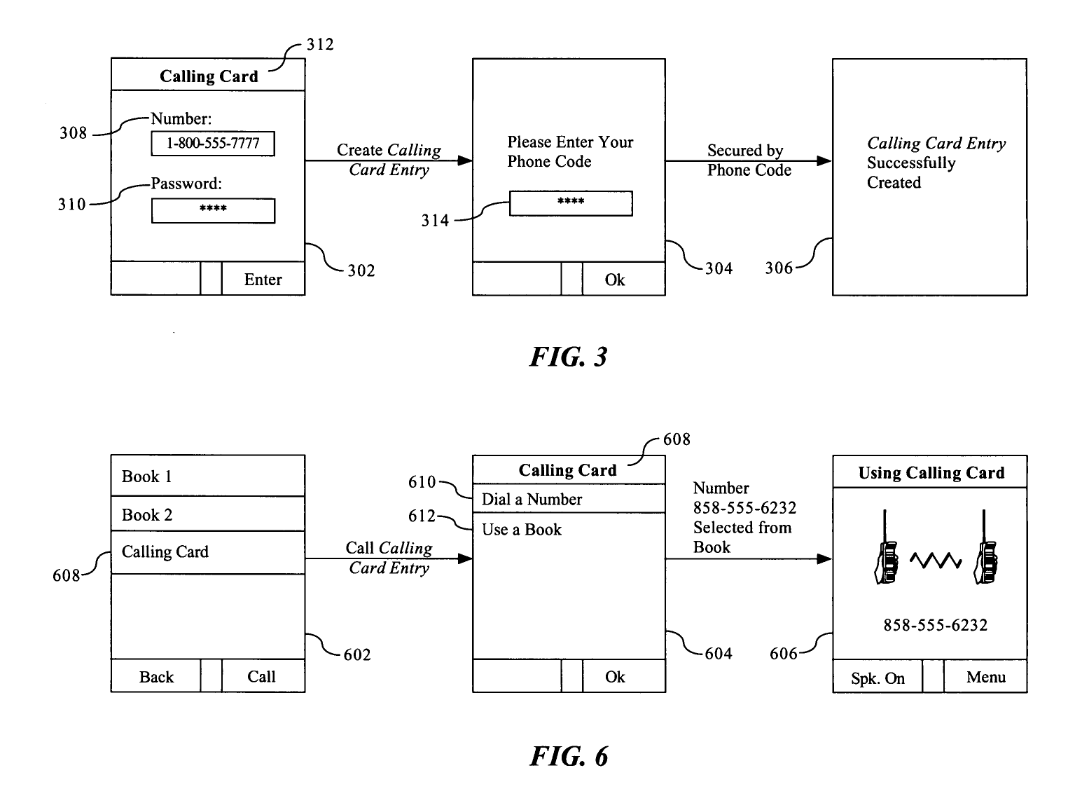

FIG. 3 illustrates exemplary screens 302, 304 and 306 displayed by the display 116 of the mobile telephone 100 (FIG. 1) when a calling card access number 308 and a calling card password 310 are saved in a memory 104 of the mobile telephone 100 and protected by a phone code 314 in accordance with an exemplary embodiment of the present invention. On the screen 302, under a calling card feature 312, a user is given an option to save the calling card access number 308 along with the calling card password 310. The calling card access number 308 may include any number of digits. Under some circumstances, a user may have several calling cards issued by different telephone companies, each calling card being associated with a calling card access number and a calling card password. The present invention may enable such user to save multiple calling card access numbers along with their respective calling card passwords on the mobile telephone. For example, on the screen 302, under the calling card feature 312, a user may be given an option (not shown) to save a calling card name (e.g., the name of the telephone company which issued the calling card, or the like) and its associated calling card access number and calling card password. This way, multiple calling card names, each with an associated calling card access number and a calling card password, may be saved on the mobile telephone 100. This completed calling card entry is protected by the phone code 314 selected by the user.

FIG. 4 illustrates a method 400 for using a mobile telephone to make a calling card telephone call based on saved calling card information in accordance with an exemplary embodiment of the present invention. The method 400 may be implemented following the step 206 shown in FIG. 2 using the mobile telephone 100 shown in FIG. 1. The saved calling card information may include a calling card access number and a calling card password saved on the mobile telephone by a user in advance, which may be protected by a phone code selected by the user. As shown in FIG. 4, upon selection of a calling card feature of the mobile telephone by the user, the user is prompted to enter a PIN (Personal Identification Number) 402. When the PIN matches the phone code selected previously by the user, the user is prompted to select or enter a telephone number to call 404. The telephone number may be selected by the user from a phone book or an address book via a screen of the mobile telephone. The saved calling card access number is dialed to make the calling card telephone call to the telephone number 406.

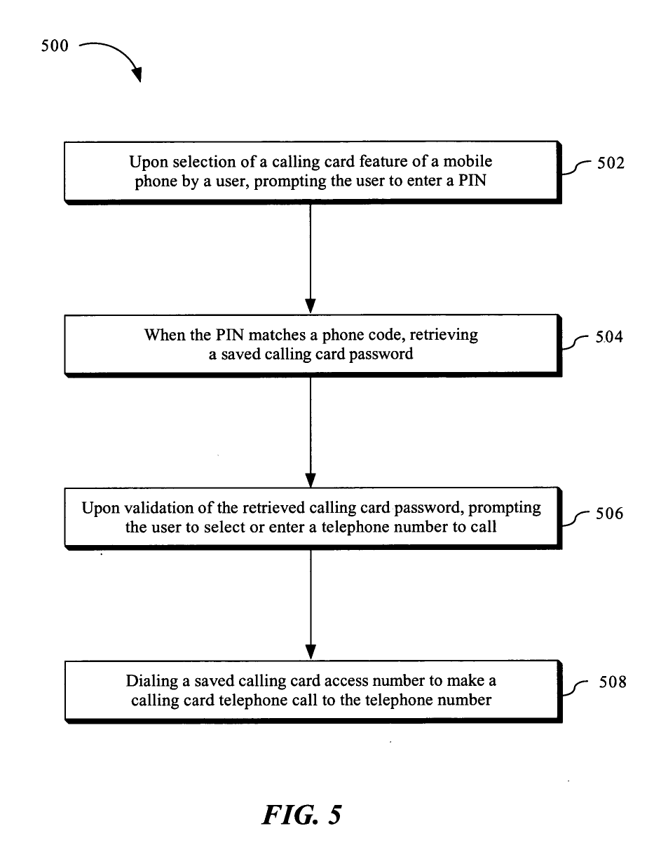

FIG. 5 illustrates a method 500 for using a mobile telephone to make a calling card telephone call based on saved calling card information in accordance with an additional exemplary embodiment of the present invention. The method 500 may be implemented following the step 206 shown in FIG. 2 using the mobile telephone 100 shown in FIG. 1. The saved calling card information may include a calling card access number and a calling card password saved in a memory of the mobile telephone by a user in advance, which may be protected by a phone code selected by the user. As shown in FIG. 5, upon selection of a calling card feature of a mobile telephone by a user, the user is prompted to enter a PIN 502. When the PIN matches the phone code selected previously by the user, the saved calling card password is retrieved 504. Upon validation of the retrieved calling card password, the user is prompted to select or enter a telephone number to call 506. The telephone number may be selected by the user from a phone book or an address book via a screen of the mobile telephone. The saved calling card access number is dialed to make the calling card telephone call to the telephone number 508.

FIG. 6 illustrates exemplary screens 602, 604 and 606 displayed by the display 116 of the mobile telephone 100 (FIG. 1) when saved calling card information is used to make a calling card telephone call in accordance with an exemplary embodiment of the present invention. On the screen 602, when a user selects a calling card feature 608, the user is asked for entering a phone code. Optionally, when the saved calling card information includes multiple calling card names and their associated calling card access numbers and calling card passwords, the calling card feature 608 may enable the user to select which calling card to use to make the calling card telephone call. For example, the calling card feature 608 may include an icon (not shown) representing the name of the selected calling card (e.g., the name of the telephone company which issued the selected calling card, or the like). Upon the validation of the phone code (i.e., when the entered phone code matches the phone code previously selected by the user), the calling card password saved for the (selected) calling card entry is picked and passed in the password mode “*” on the calling screen (not shown). After the calling card password validation is over, under the calling card feature 608 of the screen 604, the user is provided with two options. The first option 610 is to enter a phone number of the party to call. The second option 612 is to select a phone number of the party to call from a book (a phone book, an address book, or the like) saved on the mobile telephone. The screen 606 shows that a number 858-555-6232 is selected from the book.

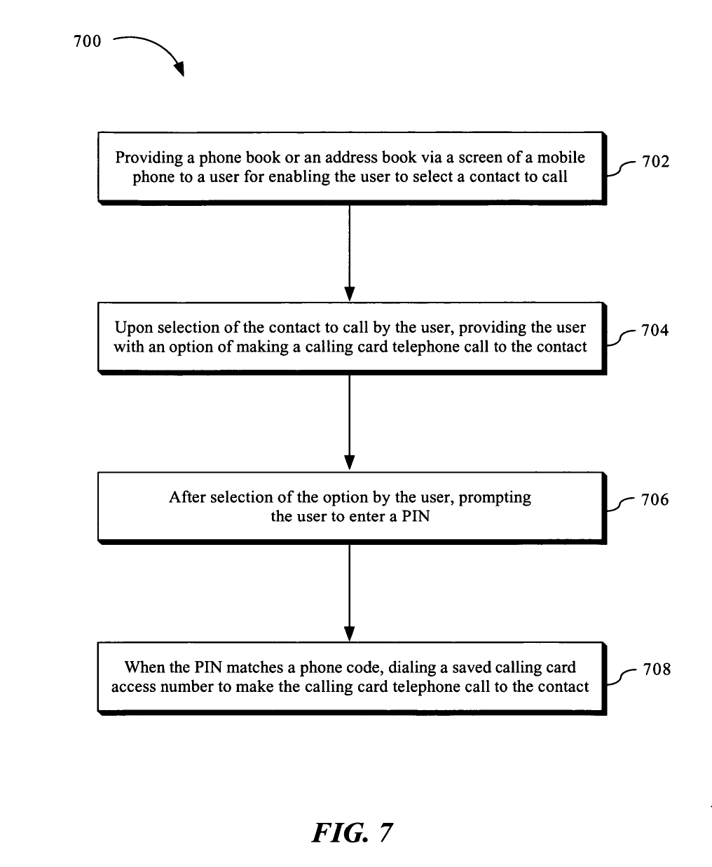

FIG. 7 illustrates a method 700 for using a mobile telephone to make a calling card telephone call based on saved calling card information in accordance with another exemplary embodiment of the present invention. The method 700 may be implemented following the step 206 shown in FIG. 2 using the mobile telephone 100 shown in FIG. 1. The saved calling card information may include a calling card access number and a calling card password saved on the mobile telephone by a user in advance, which may be protected by a phone code selected by the user. As shown in FIG. 7, a phone book, an address book or the like is provided to a user via a screen of a mobile telephone for enabling the user to select a contact to call 702. Upon selection of the contact to call by the user, the user is provided with an option of making a calling card telephone call to the contact 704. After selection of the option of making a calling card telephone call by the user, the user is prompted to enter a PIN 706. When the PIN matches the phone code previously selected by the user, the saved calling card access number is dialed to make the calling card telephone call to the contact 708.

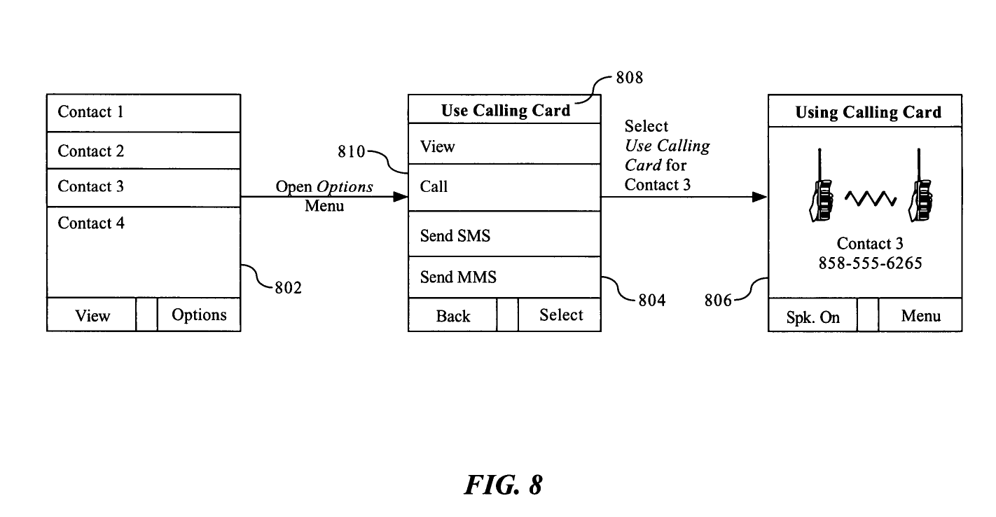

FIG. 8 shows different screens 802, 804 and 806 displayed by the display 116 of the mobile telephone 100 (FIG. 1) when saved calling card information is used to make a calling card telephone call in accordance with another exemplary embodiment of the present invention. On the screen 802, four contacts from an address book or phone book or the like are provided to a user to call. After the user picks Contact 3 to call, under a use calling card feature 808 of the screen 804, the user is prompted to enter a phone code (not shown). Optionally, when the saved calling card information includes multiple calling card names and their associated calling card access numbers and calling card passwords, the calling card feature 808 may enable the user to select which calling card to use to make the calling card telephone call. For example, the calling card feature 608 may include an icon (not shown) representing the name of the selected calling card (e.g., the name of the telephone company which issued the selected calling card, or the like). After the phone code verification, the user selects a “Call” feature 810. Then the selected Contact 3 is called automatically using the (selected) calling card entry. This way the user does not need to go through the time consuming task of entering the calling card access number, calling card password, and the contact's telephone number.

It is to be noted that the foregoing described embodiments according to the present invention may be conveniently implemented using conventional mobile telephones programmed according to the teachings of the present specification, as will be apparent to those skilled in the mobile telephone art. Appropriate software coding may readily be prepared by skilled programmers based on the teachings of the present disclosure, as will be apparent to those skilled in the software art.

It is to be understood that the present invention may be conveniently implemented as a software package. Such a software package may be a computer program product which employs a computer-readable storage medium including stored computer code which is used to program a mobile telephone to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions. The software package may, in some embodiments, be transmitted to the mobile telephone via a wireless network and thereafter implemented by the mobile telephone thereby allowing the mobile telephone to make a calling card telephone call in accordance with the present invention.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not necessarily meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for using a mobile telephone to make a calling card telephone call, comprising:
receiving, by the mobile telephone, an input of calling card information, the calling card information including a calling card access number and a calling card password;
saving the calling card information in a memory of the mobile telephone;
protecting the saved calling card information with a phone code; and
retrieving the saved calling card information to make the calling card telephone call from the mobile telephone.

2. The method as claimed in claim 1, further comprising:
prompting the user to enter a PIN;
if the PIN matches the phone code, prompting the user to at least one of select or enter a telephone number to call; and
dialing the calling card access number retrieved from memory and transmitting the password to make the calling card telephone call to the telephone number.

3. The method as claimed in claim 2, wherein the telephone number is selected by the user from at least one of a phone book or address book via a screen of the mobile telephone.

4. The method as claimed in claim 1, further comprising:
prompting the user to enter a PIN;
if the PIN matches the phone code, retrieving the saved calling card password;
upon validation of the retrieved calling card password, prompting the user to at least one of select or enter a telephone number to call; and
dialing the calling card access number and transmitting the password to make the calling card telephone call to the telephone number.

5. The method as claimed in claim 4, wherein the telephone number is selected by the user from at least one of a phone book or address book via a screen of the mobile telephone.

6. The method as claimed in claim 1, further comprising:
providing at least one of a phone book or address book via a screen of the mobile telephone to the user for enabling the user to select a contact to call;
upon selection of the contact to call by the user, providing the user with an option of making the calling card telephone call to the contact;
after selection of the option by the user, prompting the user to enter a PIN; and
when the PIN matches the phone code, dialing the calling card access number and transmitting the password to make the calling card telephone call to the contact.

7. The method as claimed in claim 1, wherein the phone code is a 4-digit number.

8. A mobile telephone, comprising:
a memory for storing calling card information, the calling card information including a calling card access number and a calling card password, access to the calling card information being protected by a phone code;
a processing system communicatively coupled with the memory for causing the mobile telephone to place a calling card telephone call; and
an input device communicatively coupled with the processing system for receiving the entry of a PIN;
wherein upon receiving the PIN, the processing system compares the PIN with the phone code and, if the PIN and phone code match, retrieves the calling card information from the memory, dials the calling card access number and transmits the calling card password and a telephone number to be called.

9. The mobile telephone as claimed in claim 8, further comprising a display for displaying a prompt for prompting a user of the mobile telephone to enter the PIN, wherein, if the PIN matches the phone code, the display further displays a prompt for prompting the user to at least one of select or enter the telephone number to be called.

10. The mobile telephone as claimed in claim 9, wherein the telephone number is selected by the user from at least one of a phone book or address book via a screen of the mobile telephone.

11. The mobile telephone as claimed in claim 9, wherein the display further displays a prompt for prompting the user to validate the retrieved calling card password.

12. The mobile telephone as claimed in claim 8, wherein the display displays at least one of a phone book or address book to the user for enabling the user to select a contact to call, and upon selection of the contact to call by the user, the display displays a prompt providing the user with an option of making the calling card telephone call to the contact.

13. The mobile telephone as claimed in claim 8, wherein the input device comprises a keypad assembly.

14. The mobile telephone as claimed in claim 8, wherein the phone code is a 4-digit number.

15. A mobile telephone, comprising:
means for receiving, by the mobile telephone, an input of calling card information, the calling card information including a calling card access number and a calling card password;
means for saving the calling card information in a memory of the mobile telephone; and
means for protecting the saved calling card information with a phone code,
wherein the saved calling card information is suitable for enabling a user to make a calling card telephone call from the mobile telephone.

16. The mobile telephone as claimed in claim 15, further comprising:
upon selection of a calling card feature of the mobile telephone by the user, means for prompting the user to enter a PIN;
if the PIN matches the phone code, means for prompting the user to at least one of select or enter a telephone number to call; and
means for dialing the calling card access number to make the calling card telephone call to the telephone number.

17. The mobile telephone as claimed in claim 16, wherein the telephone number is selected by the user from at least one of a phone book or address book via a screen of the mobile telephone.

18. The mobile telephone as claimed in claim 15, further comprising:
upon selection of a calling card feature of the mobile telephone by the user, means for prompting the user to enter a PIN;
if the PIN matches the phone code, means for retrieving the saved calling card password;
upon validation of the retrieved calling card password, means for prompting the user to at least one of select or enter a telephone number to call; and
means for dialing the calling card access number to make the calling card telephone call to the telephone number.

19. The mobile telephone as claimed in claim 18, wherein the telephone number is selected by the user from at least one of a phone book or address book via a screen of the mobile telephone.

20. The mobile telephone as claimed in claim 15, further comprising:
means for providing at least one of a phone book or address book via a screen of the mobile telephone to the user for enabling the user to select a contact to call;
upon selection of the contact to call by the user, means for providing the user with an option of making the calling card telephone call to the contact;
after selection of the option by the user, means for prompting the user to enter a PIN; and
when the PIN matches the phone code, means for dialing the calling card access number to make the calling card telephone call to the contact.
